(19) United States
(12) Patent Application Publication
(10) Pub. No.: US 2016/0285704 A1
(43) Pub. Date: Sep. 29, 2016

(54) TECHNOLOGIES FOR DYNAMIC NETWORK ANALYSIS AND PROVISIONING

(71) Applicants: Iosif Gasparakis, Tigard, OR (US); Michael Kounavis, Portland, OR (US)

(72) Inventors: Iosif Gasparakis, Tigard, OR (US); Michael Kounavis, Portland, OR (US)

(21) Appl. No.: 14/671,326

(22) Filed: Mar. 27, 2015

(51) Int. Cl. H04L 12/26

(52) U.S. Cl. CPC H04L 43/02; H04L 43/08; H04L 43/04

(57) ABSTRACT

Technologies for performing network analysis of a network include a network analytics node to determine one or more features of network traffic of the network. Each feature includes indexes associated with a link property, a protocol, and a time property. The network analytics node monitors the network traffic of the network based on the one or more features and generates one or more observation vectors. Each observation vector includes a plurality of the one or more features based on the monitored network traffic. The network analytics node performs a statistical network analysis of the network traffic based on the generated one or more observation vectors to generate a probabilistic model of the network traffic.

### BACKGROUND

Computer and telecommunication networks often have high availability requirements for provisioning purposes in order to provide user services, log transactions, carry out requests, and update files. To some extent, technologies such as network function virtualization (NFV) and software-defined networking (SDN) have aided in this regard. Network function virtualization is a network architecture that uses virtualization-related technologies to virtualize entire classes of network node functions into building blocks that may be connected, or chained, to create communication services. Software-defined networking is a networking architecture in which decisions regarding how network traffic is to be processed and the devices or components that actually process the network traffic are decoupled into separate planes (i.e., the control plane and the data plane). In software-defined networking environments, a centralized SDN controller (or “administrator”) may be used to make forwarding decisions for network traffic instead of a network device such as, for example, a network switch. Typically, forwarding decisions are communicated to a network device operating in the SDN environment, which in turn forwards network packets associated with the network traffic to the next destination based on the forwarding decisions made by the SDN controller. While such technologies have provided improvements in network provisioning and communication, existing technologies generally fail to provide sufficient flexibility to dynamically provision a network.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for network analysis and provisioning;

FIG. 2 is a simplified block diagram of at least one embodiment of an environment of a network analytics node of the system of FIG. 1;

FIG. 3 is a simplified diagram of at least one embodiment of a model network environment of a plurality of nodes for network analysis and provisioning; and

FIGS. 4-5 is a simplified flow diagram of at least one embodiment of a method for dynamic network analysis and provisioning that may be executed by the network analytics node of FIG. 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any tangibly-embodied combination thereof. The disclosed embodiments may also be implemented as instructions carried by or stored on one or more non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

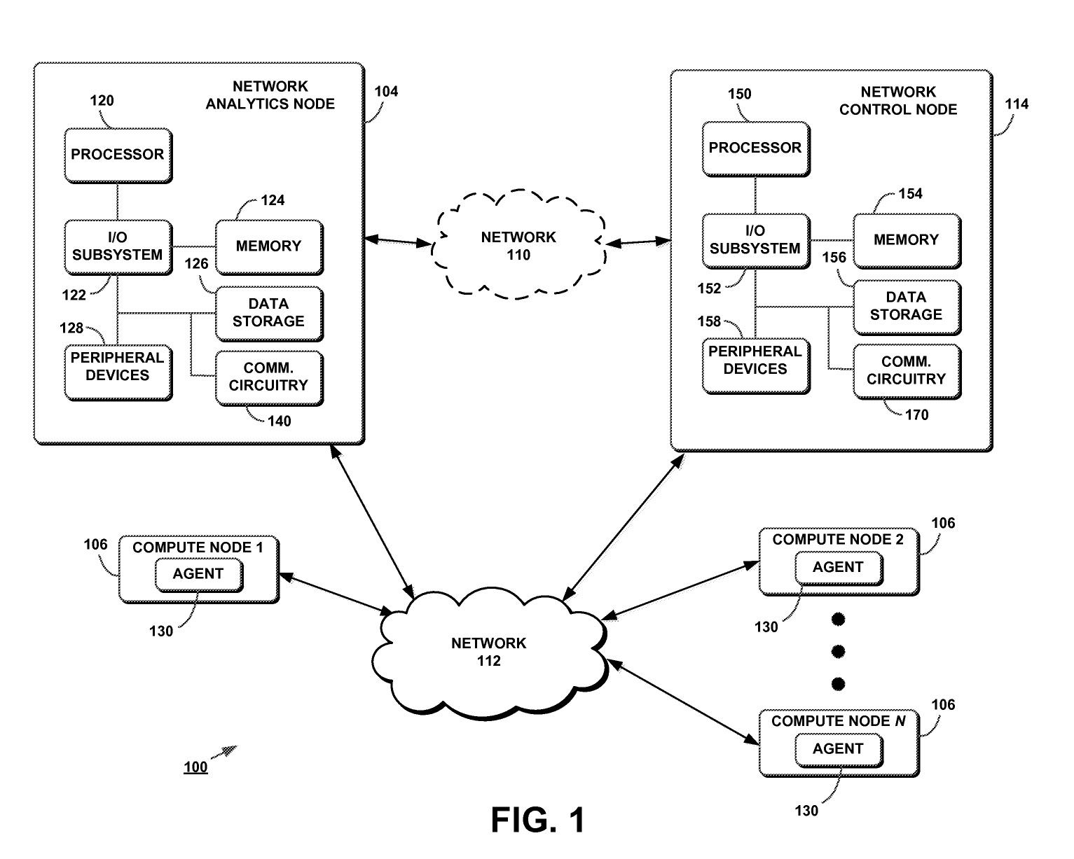

Referring now to FIG. 1, in an illustrative embodiment, a system 100 for network/traffic analysis and provisioning includes a network analytics node 104, a plurality of computer network nodes 106 (e.g., compute nodes), a network 112, and a network control node 114. In some embodiments, the system 100 may also include a network 110 (e.g., a management network) that connects the network analytics node 104 and the network control node 114 (e.g., to separate the data and control planes). In such embodiments, the network 110 allows management and control data to be securely exchanged without further communication between the network analytics node 104 and the computer network nodes 106 or between the network control node 114 and the computer network nodes 106. In one embodiment, the network 110 is embodied as a separate physical network. In another embodiment, the network 110 is embodied as a virtual network that is realized using the network 112 (e.g., a physical network) and configured to share communication resources with the computer network nodes 106. It should be appreciated that, in some embodiments, the network 110 is inaccessible by the computer network nodes 106. Although only one network analytics node 104, one network 112, and one network control node 114 are illustratively shown in FIG. 1, the system 100 may include any number of network analytics nodes 104, networks 112, and/or network control nodes 114 in other embodiments. For example, the system 100 may utilize multiple network analytics nodes 104 to analyze a particular network (e.g., via distributed analytics). It should be appreciated that the system 100 may include any number of computer network nodes 106 depending on the particular embodiment and the particular network(s) 112. Additionally, in the illustrative embodiment, the network analytics node 104, the network control node 114, and the computer network nodes 106 may communicate with each other over a network 112, for example, using packet-switched or other suitable communication. Further, in embodiments including a network 110, it should be appreciated that the system 100 may include multiple physical and/or virtual networks 110, which are utilized to exchange control and management data, interconnecting the network analytics nodes 104 with the network control nodes 114 (i.e., if the system 100 includes multiple nodes 104, 114).

As described in detail below, the system 100 operates to collect incoming traffic data for the system 100 at a node, such as the network analytics node 104, and perform generic feature extraction on the traffic data to form a sequence of index assignment operations, along with packet counting. The extracted features may be utilized to create generic observation vectors that may be formed using feature aggregation and range assignment. Machine learning algorithms, such as Principal Component Analysis (PCA) or Expectation Maximization (EM) may be used by the network analytics node 104 to process the observation vectors and generate a model, which may be used to change one or more network operation characteristic, such as provision network resources, by sending instructions to network control node 114, and/or any of computer network nodes 106.

The network analytics node 104 may be embodied as any type of computing node or computing device capable of performing workload management and orchestration functions for at least a portion of the system 100 and performing the various other functions described herein. For example, the network analytics node 104 may be embodied as a server, desktop computer, gateway device, router, switch, wireless access point, programmable logic controller, smart device, cellular phone, smartphone, wearable computing device, personal digital assistant, mobile Internet device, laptop computer, tablet computer, notebook, netbook, Ultrabook™, Hybrid device, embedded computing device, and/or any other computing/communication device. In some embodiments, the network analytics node 104 may be embodied as a managed network node, managed switch, or other computation device configured with provisioning capabilities over a computer network. Further, in some embodiments, the network analytics node 104 may be embodied as a software-defined networking (SDN) controller and/or a network functions virtualization (NFV) manager and network orchestrator (MANO). It should be appreciated that, in some embodiments, the network analytics node 104 and/or the network control node 114 may be embodied as a collection of computing devices working cooperatively with one another. Further, in some embodiments, it should be appreciated that the network analytics node 104 and the network control node 114 may be co-located (e.g., on the same computing device). In the illustrative embodiment of FIG. 1, the network analytics node 104 includes a processor 120, an input/output (“I/O”) subsystem 122, a memory 124, a data storage 126, one or more communication circuitry 140, and one or more peripheral devices 128. Of course, the network analytics node 104 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. Similarly, the memory 124 may be embodied as any type or number of volatile or non-volatile memory or data storage capable of performing the functions described herein. In operation, the memory 124 may store various data and software used during operation of the network analytics node 104 such as operating systems, applications, programs, libraries, and drivers. The memory 124 is communicatively coupled to the processor 120 via the I/O subsystem, which may be embodied as circuitry and/or components to facilitate input/output operations with the processor 120, the memory 124, and other components of the network analytics node 104. For example, the I/O subsystem 122 may be embodied as, or otherwise include, memory controller hubs, input/output control hubs, sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with processor 120, memory 124, and other components of the network analytics node 104, on a single integrated circuit chip.

The data storage 126 may be embodied as any type of device or devices configured for short-term or long-term storage of data such as, for example, memory devices and circuits, memory cards, hard disk drives, solid-state drives, or other data storage devices. The data storage 126 and/or the memory 124 may store various data during operation of the network analytics node 104 as described herein.

The one or more communication circuitry 140 may be embodied as any type of communication circuit, device, or collection thereof, capable of enabling communication between the network analytics node 104 and other computing devices via one or more communication networks (e.g., local area networks, personal area networks, wide area networks, cellular networks, a global network such as the Internet, etc.). The communication circuitry 140 may be configured to use any one or more communication technologies (e.g., wireless or wired communications) and associated protocols (e.g., Ethernet, Wi-Fi®, WiMAX, etc.) to effect such communication. Further, the communication circuitry 140 may include or be otherwise communicatively coupled to a port or communication interface. For example, the port may be configured to communicatively couple the network analytics node 104 to any number of other computing devices and/or networks (e.g., physical or logical networks). In some embodiments, the communication circuitry 140 may include a network interface controller (NIC) and/or other devices/circuitry for enabling communications between the network analytics node 104 and one or more other external electronic devices and/or systems.

The peripheral devices 128 may include any number of additional peripheral or interface devices, such as speakers, microphones, additional storage devices, and so forth. The particular devices included in the peripheral devices 128 may depend on, for example, the type and/or intended use of the network analytics node 104. Of course, in some embodiments, the network analytics node 104 may not include any peripheral devices 128.

Each of the network 110 and/or the network 112 may be embodied as any type of communication network capable of facilitating communication between the nodes 104, 106, 114. As such, the network 110, 112 may include one or more networks, routers, switches, computers, and/or other intervening devices. For example, the network 110, 112 may be embodied as or otherwise include one or more cellular networks, telephone networks, local area networks (LANs), personal area networks (PANs), storage area networks (SANs), wide area networks (WANs), global area networks (GANs), publicly available global networks (e.g., the Internet), an ad hoc network, or any combination thereof. In the illustrative embodiment, the network analytics node 104 may be configured to communicate with the computer network nodes 106 and the network control node 114, collect traffic data and other network data, and provide network provisioning instructions for the computer network nodes 106 and the network control node 114 via the network 112 as discussed in more detail below. In some embodiments, the network 112 may include one or more packet schedulers (e.g., of a plurality) in order to realize network provisioning functions. Further, at least one the packet schedulers may adjust the link capacities of virtual networks by modifying one or more weight values, according to the results of the computations performed by a machine learning module. In some embodiments, one or more of the packet schedulers may form a portion of one or more of the compute nodes 106.

The network control node 114 may be embodied as any computing device or compute node capable of performing the functions described herein. For example, the network control node 114 may be embodied as a server, desktop computer, SDN controller, gateway device, router, switch, wireless access point, programmable logic controller, smart device, cellular phone, smartphone, wearable computing device, personal digital assistant, mobile Internet device, laptop computer, tablet computer, notebook, netbook, Ultrabook™, Hybrid device, embedded computing device, and/or any other computing/communication device.

As shown in FIG. 1, the illustrative network control node 114 includes a processor 150, an I/O subsystem 152, a memory 154, a data storage 156, a communication circuitry 170, and one or more peripheral devices 158. Of course, the network control node 114 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. In some embodiments, the components of the network control node 114 are similar to the corresponding components of the network analytics node 104 described above. As such, the description of those components is not repeated herein for clarity of the description.

Each of the computer network nodes 106 may be embodied as any computing device capable of performing the functions described herein. For example, each of the computer network nodes 106 may be embodied as a desktop computer, server, smart device, cellular phone, smartphone, wearable computing device, personal digital assistant, mobile Internet device, laptop computer, tablet computer, notebook, netbook, Ultrabook™, router, switch, Hybrid device, and/or any other computing/communication device. In some embodiments, one or more of the computer network nodes 106 may be embodied as a hardware component, software component, processing environment, runtime application/service instance, and/or other type of compute node (e.g., rack-mounted compute node, freestanding compute node, and/or virtual compute node). It should be appreciated that the computer network nodes 106 may include one or more components similar to the components of the network analytics node 104 and/or the network control code 114 described above. As such, the description of those components is not repeated herein for clarity of the description. Of course, the computer network nodes 106 may include other or additional components, such as those commonly found in a typical computing device (e.g., various input/output devices and/or other components) in some embodiments. Further, in some embodiments, one or more components of the network analytics node 104 may be omitted from the computer network nodes 106. It should be appreciated that, in some embodiments, each of the computer network nodes 106 may include an agent 130 (e.g., implemented in software, firmware and/or hardware) that collects the utilization data of that particular node 106 and transmits that data (e.g., via suitable communication circuitry) to the network analytics node 104. In some embodiments, the agents 130 may be connected via a local NIC to the network 110 (i.e., if the system 100 includes such a network 110). A similar agent may also be run in the capacity of the network fabric 112. In other embodiments, the network-related data and statistics regarding the network 112 may be collected by virtue of other suitable techniques, algorithms, and/or mechanisms.

In some embodiments, the system 100 may employ a protocol similar to a modified OpenFlow communications protocol. The OpenFlow protocol may provide access to a forwarding plane of a network switch or router over the network 110 (or the network 112). This enables remote controllers, such as the network control node 114 and/or the network analytics node 104, to determine a link path for packets through a network of switches in the network 112. For example, in some embodiments, OpenFlow runs on the network 110, which acts as a “sideband” interface that configured the data network 112. The separation of the control plane from the forwarding plane allows for more flexible and/or sophisticated traffic management. OpenFlow further allows remote administration of a switch's packet forwarding tables, by adding, modifying, and removing packet matching rules and actions. In this way, routing decisions may be made periodically or ad hoc by the network analytics node 104 and/or network control node 114 and translated into rules and actions with a configurable lifespan, which are then deployed to a switch's flow table, leaving the actual forwarding of matched packets to the switch at wire speed for the duration of those rules.

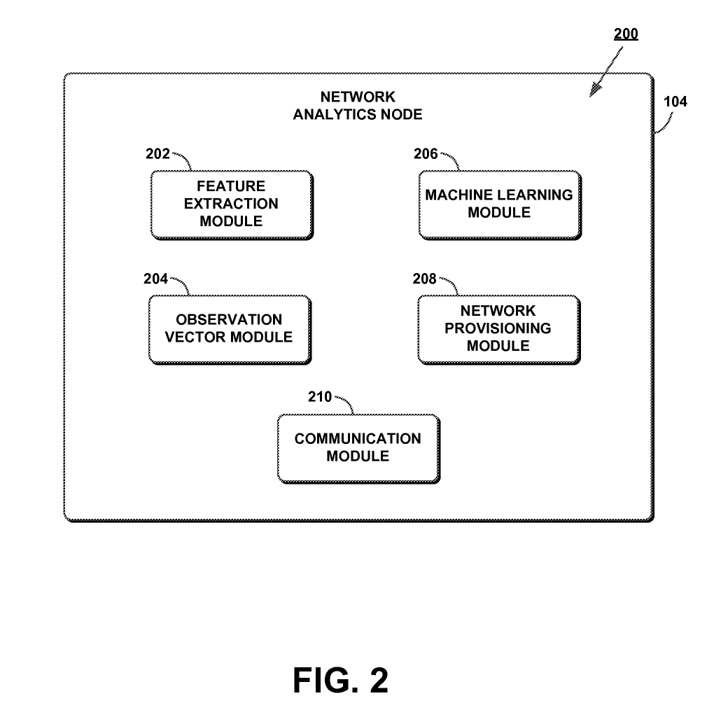

Referring now to FIG. 2, in use, the network analytics node 104 establishes an environment 200. The illustrative environment 200 of the network analytics node 104 includes a feature extraction module 202, an observation vector module 204, a machine learning module 206, a network provisioning module 208, and a communication module 210. The various modules of the environment 200 may be embodied as hardware, software, firmware, or a combination thereof. For example the various modules, logic, and other components of the environment 200 may form a portion of, or otherwise be established by, the processor 120, the I/O subsystem 122, a SoC, or other hardware components of the network analytics node 104. As such, in some embodiments, one or more of the modules of the environment 200 may be embodied as a circuit or collection of electrical devices (e.g., feature extraction circuit, an observation vector circuit, a machine learning circuit, a network provisioning circuit, and/or a communication circuit). Additionally, in some embodiments, one or more of the illustrative modules may form a portion of another module.

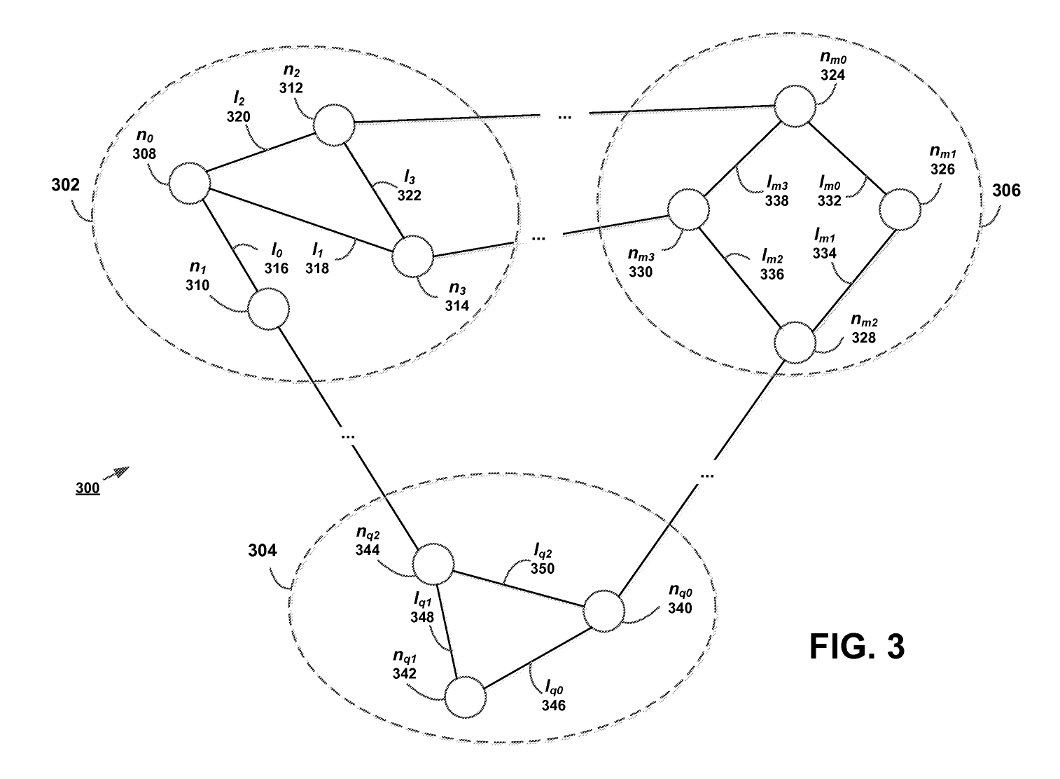

The feature extraction module 202 is configured to extract features from raw network traffic, such as packet quantities and their header properties. In some embodiments, the feature extraction module 202 determines (e.g., identifies or selects) one or more features to be analyzed associated with network traffic. As described below, each of the features may include a link property, protocol property, and/or time property. Of course, in other embodiments, the features may include additional or alternative types of properties depending on the particular embodiment. Further, it should be appreciated that the feature extraction module 202 may determine the features based on any suitable technique, algorithm, and/or mechanism. In an embodiment, a particular feature may describe all TCP traffic that flow through the q neighborhood (see FIG. 3) of the network every Monday. In such an embodiment, the link property identifies the network links (e.g., the link indexes) in the q neighborhood (e.g., links l_{q0}-l_{q2} of FIG. 3), the protocol property identifies the network protocol as TCP, and the time property identifies Monday as the day of the week for analysis; each of the other indexes of the properties may be assigned wildcard or “do not care” values. As described below, in some embodiments, the feature extraction module 202 monitors the network traffic based on the determined features and track the data (e.g., the bytes) in the network traffic that are associated with the indexes of the features (e.g., the bytes of all TCP packets that traverse the q neighborhood on a Monday in the embodiment described above).

The observation vector module 204 is configured to generate observation vectors that include the features determined by the feature extraction module 202. It should be appreciated that the particular features included in the observation vectors may vary depending on the particular embodiment and may be determined/selected according to any suitable technique, algorithm, and/or mechanism. In some embodiments, aggregation of the features into observation vectors permits network traffic analysis and provisioning to be performed on multiple entities of the network simultaneously. For example, in the embodiment described above regarding monitoring TCP traffic on Mondays, features can be defined that described all TCP traffic that flows through each specific link of the network such that aggregation of those features into an observation vector results in a description (e.g., a complete description) of the TCP traffic that flows through all links of the network at that time. In some embodiments, the observation vector module 204 may arrange the observation vectors in the form of an observation matrix as described below. In the illustrative embodiment, the observation vector module 204 determines one or more observation periods that define the period(s) over which features are monitored/counted and observation vectors are created. In some embodiments, the feature extraction module 202 continuously monitors and records data associated with the features and the observation vector module 204 retrieves the appropriate data based on the determined observation period. In other embodiments, the feature extraction module 202 and the observation vector module 204 work cooperatively such that the feature extraction module 202 records only data that is consistent with the determined observation period. In yet another embodiment, the monitoring and recording of data and generation of the observation vectors may be performed according to another suitable scheme.

The machine learning module 206 is configured to perform a statistical network analysis of the network traffic based on the observation vectors (or, more generally, based on the features) to generate a probabilistic model of the network traffic of the system 100. It should be appreciated that, in some embodiments, the machine learning module 206 may be configured to “learn” from the received network traffic data and build a model based on the inputs and use the generated model to make predictions or decisions on network provisioning as discussed in more detail below. It should further be appreciated that the machine learning module 206 may utilize any suitable techniques, algorithms, and/or mechanisms to perform the statistical network analysis and/or generate the probabilistic model. As described below, the machine learning module 206 may utilize principal component analysis (PCA) and/or expectation maximization (EM) in order to generate an appropriate probabilistic model.

It should be appreciated that principal component analysis is a statistical technique that utilizes an orthogonal transformation to convert a set of observations of possibly correlated variables into a set of values of linearly uncorrelated variables, or “principal components.” In some embodiments, the number of principal components may be less than or equal to the number of original variables. Additionally, in some embodiments, the orthogonal transformation may be defined in such a way that the first principal component has the largest possible variance (i.e., accounts for as much of the variability in the data as possible), and each succeeding component in turn has the highest variance possible under the constraint that it is orthogonal to (i.e., uncorrelated with) the preceding components. The principal components may be considered orthogonal because they are the eigenvectors of the covariance matrix. In some embodiments, principal component analysis may operate similarly to eigenvector-based multivariate analyses in that the processing may reveal the internal structure of the collected network data in a way that explains (e.g., best explains) the variance in the data.

It should further be appreciated that expectation maximization (EM) may be configured to iteratively find maximum likelihood or maximum a posteriori (MAP) estimates of network parameters in statistical models, where the model may depend on unobserved latent variables. The expectation maximization iteration may alternate between performing an expectation or estimating step, which creates a function for the expectation of the log-likelihood evaluated using a current estimate for the parameters, and a maximization step, which computes parameters maximizing the expected log-likelihood found on the expectation step. These parameter-estimates may then be used to determine the distribution of the latent variables in the next expectation step. It should be understood by those skilled in the art that multiple other or additional machine-learning algorithms (e.g., clustering analysis, dimensionality reduction, artificial neural network, cluster analysis, etc.) may be utilized by the machine learning module 206 to model operational network characteristics for provisioning purposes.

The network provisioning module 208 is configured to generate dynamic provisioning instructions (e.g., to configure provisioning capacities) for the network based on the generated probabilistic model. It should be appreciated that the particular dynamic provisioning instructions may vary significantly depending on the particular probabilistic model and/or the context of the network. As described below, in an embodiment, the network provisioning module 208 may provide instructions to adjust link capacities of virtual access networks based on a sudden increase in network traffic identified based on the probabilistic model (e.g., collected in a minute/hour time scale). In another embodiment, the adjustment of virtual link capacities may be realized through modifying a weight value(s) of a packet scheduler(s). As discussed above, in some embodiments, the packet scheduler(s) may be part of the compute node 106.

The communication module 210 handles the communication between the network analytics node 104 and remote devices (e.g., the network control node 114 and/or the computer network nodes 106) through a network (e.g., the network 112). For example, as described herein, the communication module 210 receives data associated with the network traffic, which may be analyzed based on the various determined features, and transmits instructions associated with dynamic provisioning of the network.

Referring now to FIG. 3, an illustrative embodiment of a model network environment 300 including a plurality of nodes for network traffic analysis and network provisioning is shown. The network environment 300 includes a plurality of sub-networks (also referred to herein as “sub-nets” or “neighborhoods”) 302-304 whose nodes (e.g., nᵢ) and links (e.g., lᵢ) may be part of intranets, data center networks, autonomous systems, and/or other sub-networks. It should be appreciated that the network environment 300 may be characterized as a collection of nodes (N), represented by the set N={nᵢ,0≦i≦c_{N}}, and a collection of links (L) represented by the set L={lᵢ,0≦i≦c_{L}}, where nᵢ represents the i^{th} node in the environment 300, lᵢ represents the i^{th} link in the environment 300, c_{N} represents a total number of nodes in the environment 300, and c_{L} represents a total number of links in the environment 300. In some embodiments, the nodes 308-314, 324-330, 340-344 may be embodied as computer network nodes 106 and/or and one or more network control nodes 114 (depending on the particular network configuration). Further, in the illustrative embodiment, at least one of the nodes 308-314, 324-330, 340-344 is embodied as a network analytics node 104.

In the illustrative embodiment, the sub-network 302 comprises nodes n₀-n₃ (308-314) and links l₀-l₃ (316-322), while the neighboring sub-network 306 (“m neighborhood”) comprises nodes nₘ₀-nₘ₃ (324-330) and links lₘ₀-lₘ₃ (332-338), and neighboring sub-network 304 (“q neighborhood”) comprises nodes n_{q0}-n_{q2} (340-344) and links l_{q0}-l_{q2} (346-350). Of course, it should be understood by those skilled in the art that each the sub-networks 302, 304, 306 may include more or fewer nodes and/or links than that illustrated in FIG. 3. In some embodiments, the network model environment 300 may be a physical network, where the capacities of the links may represent bandwidth physically present at the infrastructure. Further, the network model environment 300 may be a software-defined virtual network (SDN) where link capacities may be represented by virtual quantities. In such a case, link capacities may be allocated through a dynamic provisioning process, where capacity allocations may be enforced through packet scheduling running in the physical nodes of the network. Here, a “parent” network may divide its resources among “child” virtual networks potentially realized as software-defined networks, where provisioning mechanisms may allocate link capacities for these child networks.

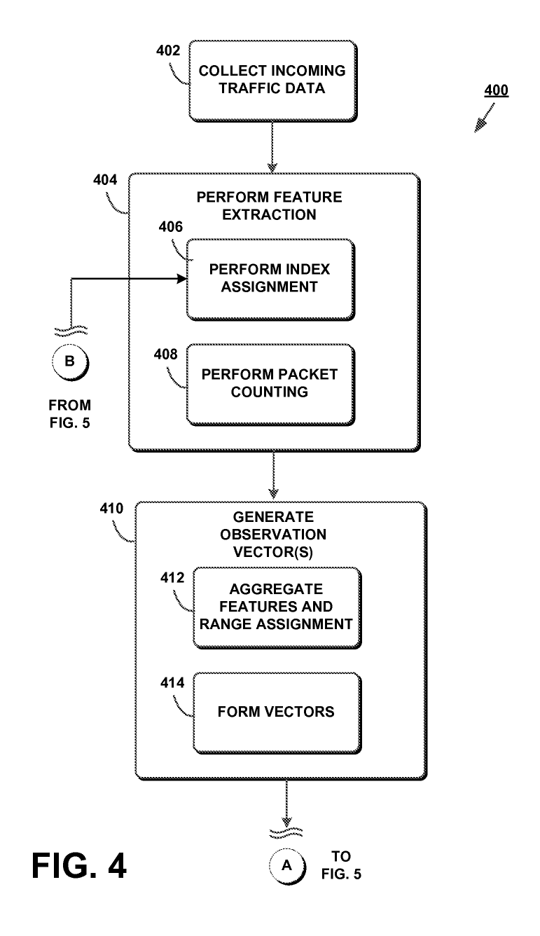

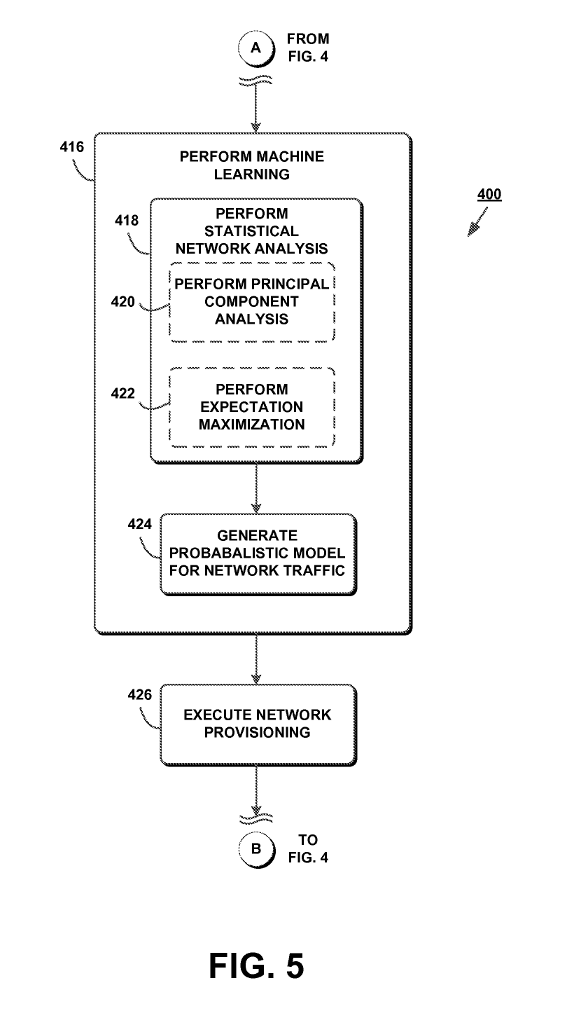

Referring now to FIGS. 4-5, the network analytics node 104 may execute a method 400 for dynamic network analysis and provisioning. The illustrative method 400 begins with block 402 of FIG. 4 in which incoming traffic data from the network 112 is received by the network analytics node 104. It should be appreciated that the network analytics node 104 may be configured to receive the network traffic data by virtue of any suitable technique or mechanism including, for example, network traffic capturing techniques such as “network sniffing” or receiving data from the local agents 130 in the compute node(s) 106 and/or switches. In block 404, the network analytics node 104 extracts the raw characteristics of the network traffic (i.e., packet quantities and their header properties) into features of interest for the purposes of provisioning, wherein features of interest may include link properties (l), protocol field properties (p) and time properties (t). In doing so, in block 406, the network analytics node 104 may perform index assignment for one or more features. For example, the network analytics node 104 may be configured to determine a feature as a function of predetermined indexed properties of interest (e.g., link properties (l), protocol field properties (p) and time properties (t)). The feature or features of interest for modeling may be characterized as a property of the network traffic, or

$$f ( {l}_{{i}_{1}} , {l}_{{i}_{1}} … , {l}_{{i}_{{c}_{M}}} , {p}_{{i}_{1}} , {p}_{{i}_{1}} … , {p}_{{i}_{{c}_{Q}}} , {t}_{{i}_{1}} , {t}_{{i}_{1}} … , {t}_{{i}_{{c}_{T}}} ) ,$$

where the function ƒ is associated with c_{M} link (l) properties indexed by i₁, i₂, . . . , i_{c}_{_{M}}, c_{Q} protocol field properties (p) indexed by i₁, i₂, . . . , i_{c}_{_{Q}}, and c_{T} time properties (t) indexed by i₁, i₂, . . . , i_{c}_{_{T.}}

The link indexes may be configured to identify the links of the network topology where traffic associated with the feature flows. The link indexes may be associated with links of specific subnets or entire subnets themselves. By utilizing these indexes, a feature of interest may be associated with a single link, a plurality of links, or no links at all. The protocol field (p) indexes may be configured to specify protocol field values, for example, in the headers of the packets associated with the feature. In some embodiments, the protocol field values may be embodied as IP source-destination addresses (e.g., internet protocols IPv4, IPv6, etc.), port numbers, protocol identifiers (e.g., Transmission Control Protocol (TCP), User Datagram Protocol (UDP), Internet Control Message Protocol (ICMP), etc.), and/or any other suitable set of rules (protocols) that may govern communications between nodes, devices, etc. in the network environment 300. A feature of interest may be associated with a specific protocol (e.g., TCP), a specific origin-destination (OD) flow, a collection or combination of protocols/OD flows, or no protocol field values at all.

In some embodiments, time (t) indexes may specify time ranges or intervals as a hierarchy of epochs, where the epochs may be minutes, hours, days, weeks, months, etc. A first index i₁ may specify a time interval t₁ associated with a smallest epoch (e.g., one minute). A second index i₂ may specify a time interval t₂ associated with a next-smallest epoch (e.g., one hour). Similarly, remaining indexes (e.g., i₃, i₄, and i₅) may be associated with progressively larger epochs (e.g., days, weeks, months, years, etc.).

Additionally, in some embodiments, indexes may be assigned a single specific value, a collection of values from a range, and/or a “wildcard” (or “don't care”) value (*). For example, a feature of interest ƒ₁ may describe all TCP traffic flows through the q neighborhood 304 of the network environment 300 (see FIG. 3) for a particular day (e.g., every Monday). The network analytics node 104 may assign wildcard values for all link indexes outside the q neighborhood 304 (e.g., sub-networks 302, 306). Further, the network analytics node 104 may assign the values of the q neighborhood as indexes associated with the q neighborhood. As the feature of interest in this example concerns TCP traffic flows, the field identifying the network protocol may be set to “TCP”, while all other protocol field indexes may be set to a wildcard value. The time index specifying the epoch (e.g., day of the week) may be set to the time period of interest (e.g., Monday), and all other time indexes may be assigned wildcard values. These index assignments may be characterized for the links according to:

$${l}_{{i}_{1}} ← * , {l}_{{i}_{2}} ← * , … , {l}_{{i}_{m}} ← {l}_{{q}_{0}} , {l}_{{i}_{m + 1}} ← {l}_{{q}_{1}} , … , {l}_{{i}_{{c}_{M}}} ← * ,$$

and for the protocol field indexes according to:

$${p}_{{i}_{1}} ← * , {p}_{{i}_{2}} ← * , … , {p}_{{i}_{q}} ← TCP , … , {p}_{{i}_{{c}_{Q}}} ← * .$$

In block 408, the network analytics node 104 monitors the network traffic and performs packet counting. As described above, the bytes of network traffic that are associated with the indexes of the features may be counted, which may be utilized to determine, for example, information relating to traffic data volume on the network (e.g., for individual nodes, links, sub-networks, or the network as a whole).

In block 410, the network analytics node 104 indexes the features of interest, and time periods over which the features of interest are observed (e.g., the predetermined observation period), and generates observation vectors (e.g., using the observation vector module 204). In some embodiments, in block 412, the network analytics node 104 may aggregate the features of interest (e.g., per index and time range or observation period). Further, in block 414, the network analytics node 104 may generate the observation vectors based on the aggregated/selected features and, in some embodiments, may arrange them as an observation matrix (e.g., for use by the machine learning module 206 to create probabilistic models characterizing both the common and unusual behaviors of the network). In order to obtain sufficient data for generating models, traffic data may need to be collected over longer periods of time to generate enough vectors for learning. In certain cases, traffic data collection periods may need to be longer than the time periods in which features are defined.

For example, data for traffic flowing on a particular day (e.g., every Monday) may need to be collected over several weeks or months. In another example, data for the traffic flowing on a minute-by-minute or hour-by-hour basis may need to be collected over several days. As described above, the observation period may be predetermined and utilized during the generation of the corresponding observation vectors. The observation vectors (e.g., \tilde{v}₁, \tilde{v}₂, . . . , \tilde{v}ₙ) in vector form, matrix form, or otherwise may be passed to the machine learning module 206 for machine learning algorithm processing. As described herein, the features of the observation vectors (e.g., \tilde{v}₁, \tilde{v}₂, . . . , \tilde{v}ₙ) may be arranged in a matrix formation, which may be advantageous for various machine learning algorithms (e.g., to simplify the analytics). Using the observation vectors \tilde{v}₁, \tilde{v}₂, . . . , \tilde{v}ₙ as an example, an observation matrix representation of the indexed features ƒ₁, ƒ₂, . . . , ƒ_{d} may be represented according to:

$$[ \begin{matrix}{\tilde{v}}_{1} \\ {\tilde{v}}_{2} \\ ⋯ \\ {\tilde{v}}_{n}\end{matrix} ] = [ \begin{matrix}{f}_{1 , {\tilde{v}}_{1}} & {f}_{2 , {\tilde{v}}_{1}} & ⋯ & {f}_{d , {\tilde{v}}_{1}} \\ {f}_{1 , {\tilde{v}}_{2}} & {f}_{2 , {\tilde{v}}_{2}} & ⋯ & {f}_{d , {\tilde{v}}_{2}} \\ ⋮ & ⋮ & ⋱ & ⋮ \\ {f}_{1 , {\tilde{v}}_{n}} & {f}_{2 , {\tilde{v}}_{n}} & ⋯ & {f}_{d , {\tilde{v}}_{n}}\end{matrix} ] .$$

In block 416 of FIG. 5, the network analytics node 104 performs machine learning on the observation vectors to generate one or more probabilistic models of the network traffic based on the data. In doing so, in block 418, the network analytics node 104 performs statistical network analysis based on the observation vectors, and in block 424, the network analytics node 104 uses the processed results to generate one or more probabilistic models for the network traffic. In particular, in block 418, the network analytics node 104 performs statistical network analysis based on the observation vectors. It should be appreciated that the network analytics node 104 may use any suitable algorithm, technique, and/or mechanism for doing so. For example, in some embodiments, the network analytics node 104 may utilize algorithms such as clustering analysis, dimensionality reduction, artificial neural network, cluster analysis, and/or other suitable algorithms. In the illustrative embodiment, the network analytics node 104 may perform statistical network analysis based on principal component analysis in block 420 and/or based on expectation maximization in block 422.

As indicated above, principal component analysis is a statistical procedure for converting a set of observations of possibly correlated variables into a set of values of linearly uncorrelated variables (principal components). It should be appreciated that, during principal component analysis, traffic demands may be characterized as d vectors of dimension d. Further, in some embodiments, these vectors may then be split into two components such that a first component of d₁ vectors characterizes the most probable traffic demands and a second component of d₂=d−d₁ vectors characterizes unusual or abnormal network behavior. It should further be appreciated that, in the illustrative embodiment, any traffic demand may be described as a linear combination of the d vectors.

The network analytics node 104 may perform principal component analysis to compute principal components from the observation vectors \tilde{v}₁, \tilde{v}₂, . . . , \tilde{v}_{d}. In doing so, the network analytics node 104 may form a covariance matrix C, which characterizes the variations of \tilde{v}₁, \tilde{v}₂, . . . , \tilde{v}_{d} across the d dimensions. In some embodiments, vectors \tilde{v}₁, \tilde{v}₂, . . . , \tilde{v}_{d} may first go through a process of mean removal, after which the zero mean forms of \tilde{v}₁, \tilde{v}₂, . . . , \tilde{v}_{d} are used in the covariance matrix calculation. As indicated above, in the illustrative embodiment, the principal components of the network traffic are the eigenvectors of the resulting covariance matrix. In some embodiments, network link capacities for provisioning can be computed in this way from principal components. Network link capacities may be computed as a function of the maximum normal traffic demand coming from the principal components in each link. Provisioning capacities may be equal to the maximum traffic demand in each link. In certain illustrative embodiments, provisioning capacities may be proportional to the maximum traffic demand in each link (e.g., equal to the maximum traffic demand in each link, multiplied by a factor), in which selection of the factor may be dependent upon the traffic demand and/or principal components of each link.

As indicated above, the network analytics node 104 may, additionally or alternatively, utilize expectation maximization (EM). In doing so, the network analytics node 104 may apply a Gaussian mixture model (GMM) to determine a probability density function as a linear combination of Gaussian functions (or “Gaussian mixtures”). In some embodiments, the network analytics node 104 computes expectation maximization mixture parameters for a set of input values or seeds (e.g., the observation vectors that characteristic network traffic) that result in a density function that maximizes the likelihood of the seed values. In some embodiments, the network analytics node 104 may generate a probability density function used in performing expectation maximization, which may be characterized by

$$Pr ( \tilde{v} ; θ ) = {\sum }_{i = 1}^{G} \frac{{c}_{i}}{\sqrt{{( 2 π )}^{d} \cdot \vert {\sum }_{i} \vert}} \cdot {e}^{- \frac{{( \tilde{v} - {\tilde{μ}}_{i} )}^{T} \cdot {( {\sum }_{i} )}^{- 1} \cdot ( \tilde{v} - {\tilde{μ}}_{i} )}{2}} \qquad ( Eq . 1 )$$

where \tilde{v} is an input vector of dimensionality d, and θ is the Gaussian mixture model used by the algorithm. The Gaussian mixture model θ may further include a number of Gaussian mixtures G where the i-th Gaussian mixture is associated with a GMM coefficient cᵢ, a mean value vector ũᵢ, and a covariance matrix Σᵢ. In certain illustrative embodiments, the GMM coefficients cᵢ, the mean value vectors \tilde{μ}ᵢ, and the covariance matrix Σᵢ for 1≦i≦G may be the parameters of the model θ.

In some embodiments, the network analytics node 104 may make an initial estimate for the parameters of the GMM using the expectation maximization algorithm. The speed of convergence of expectation maximization may depend on how accurate the initial estimation is. Nevertheless, once an initial estimation is made, the network analytics node 104 may update the parameters of the model using the expectation maximization algorithm by taking into account the seed values \tilde{v}₁, \tilde{v}₂, . . . , \tilde{v}ₙ. In some embodiments, the i^{th} GMM coefficient is updated to a value ĉᵢ which represents the probability that the event characterized by the density of (Eq. 1) is true due to the i-th mixture being true. This probability may be averaged across seed values \tilde{v}₁, \tilde{v}₂, . . . , \tilde{v}ₙ according to:

$${\hat{c}}_{i} == \frac{1}{n} \cdot {\sum }_{j = 1}^{n} {\hat{c}}_{ij} , {\hat{c}}_{ij} = \frac{\frac{{c}_{i}}{\sqrt{{( 2 π )}^{d} \cdot \vert {\sum }_{i} \vert}} \cdot {e}^{- \frac{{( {\tilde{v}}_{j} - {\tilde{μ}}_{i} )}^{T} \cdot {( {\sum }_{i} )}^{- 1} \cdot ( {\tilde{v}}_{j} - {\tilde{μ}}_{i} )}{2}}}{Pr ( {\tilde{v}}_{j} ; θ )} . \qquad ( Eq . 2 )$$

In some embodiments, the mean value vector of the i^{th} mixture may be updated to a value \hat{μ}ᵢ which may be equal to the mean output value of a system characterized by the density of Eq. 1, where only the i^{th} mixture may be true. The mean value may then be taken across seed values \tilde{v}₁, \tilde{v}₂, . . . , \tilde{v}ₙ according to:

$${\hat{μ}}_{i} = \frac{{\sum }_{j = 1}^{n} {\hat{c}}_{ij} \cdot {\tilde{v}}_{j}}{{\sum }_{j = 1}^{n} {\hat{c}}_{ij}} .$$

In some embodiments, the covariance matrix of the i^{th} mixture may be updated to a value, Σᵢ, which may be equal to the mean covariance matrix of the output of a system characterized by the density of (Eq. 1), where only the i^{th} mixture may be true. In certain illustrative embodiments, the covariance matrix may be computed as an average across seed values \tilde{v}₁, \tilde{v}₂, . . . , \tilde{v}ₙ according to:

$${\sum }_{i} = \frac{{\sum }_{j = 1}^{n} {\hat{c}}_{ij} \cdot ( {\tilde{v}}_{j} - {\tilde{μ}}_{i} ) \cdot {( {\tilde{v}}_{j} - {\tilde{μ}}_{i} )}^{T}}{{\sum }_{j = 1}^{n} {\hat{c}}_{ij}}$$

In the illustrative embodiment, the network analytics node 104 may stop the performance of the expectation maximization algorithm when the improvement in the likelihood function computed over the seed values is smaller than a predetermined threshold.

In block 424, the network analytics node 104 utilizes the statistical network analysis to generate one or more probabilistic models for network traffic, which may be used (e.g., by the network provisioning module 208) to execute (e.g., launch, process, initialize, etc.) network provisioning in block 426. In some embodiments, by statistically analyzing the peaks of the maximum demands in each link of a network, a probability model may be generated to compute network provisioning capacities. Based on such a model, the network analytics node 104 may generate instructions for one or more nodes in a network (e.g., the network environment 300) to provision network traffic across links.

It should be understood by those skilled in the art that the technology of the present disclosure enables a multitude of configurations for network provisioning. In one example, sudden peaks in network traffic may be detected by the network analytics node 104 and modeled to provide a one-time creation of a hotspot. In such an example, the occurrence of an event (e.g., news announcement) may cause many users to access the same servers simultaneously. Utilizing statistical analysis (e.g., PCA) of the network traffic collected in a minute/hour time scale, the network analytics node 104 may identify the sudden increase in network traffic and provide instructions to adjust link capacities of virtual access networks accordingly. Techniques disclosed herein may also be utilized for static provisioning on a corporate intranet. By statistically analyzing the traffic associated with specific business groups (e.g., research and development, engineering, sales, manufacturing, etc.), this information may be provided to help the specific business groups quantify communication requirements and help provision virtual software-defined networks that facilitate communication in these groups. For example, techniques disclosed herein may be used to provision backbone networks over long time scales. By statistically analyzing the behavior of a network over long periods of time (e.g., months), specific periods of time during which traffic demand is low may be identified, thereby potentially freeing network resources.

It should also be understood by those skilled in the art that the probabilistic models disclosed herein are not limited only to network link capacities, but may be applied to origin-destination flows, and/or other characteristics and parameters as well. Thus, generated models may be used to adjust operation of a network architecture in addition to, or instead of, adjust network link capacities. In an example, generated models may be used by the network analytics node 104 to select routes, adjust routing protocols, and/or select network control and management mechanisms (e.g., using the network control node 114).

### EXAMPLES

Illustrative examples of the technologies disclosed herein are provided below. An embodiment of the technologies may include any one or more, and any combination of, the examples described below.

Example 1 includes a network analytics node for performing network analysis of a network, the network analytics node comprising a feature extraction module to (i) determine one or more features of network traffic of the network, wherein each of the one or more features includes indexes associated with a link property that identifies network links between computer network nodes of the network, a protocol property that identifies protocol field values of a header of a corresponding network packet, and a time property that identifies intervals over which the network traffic is to be monitored and analyzed, and (ii) monitor the network traffic of the network based on the one or more features; an observation vector module to generate one or more observation vectors, wherein each of the one or more observation vectors includes a plurality of the one or more features based on the monitored network traffic; and a machine learning module to perform a statistical network analysis of the network traffic based on the generated one or more observation vectors to generate a probabilistic model of the network traffic.

Example 2 includes the subject matter of Example 1, and wherein the link property identifies network links of a subset of the network.

Example 3 includes the subject matter of any of Examples 1 and 2, and wherein the link property identifies one of a single network link; a set of network links; or zero network links.

Example 4 includes the subject matter of any of Examples 1-3, and wherein the protocol property identifies at least one of an internet protocol source address, an internet protocol destination address, a port number, or a protocol.

Example 5 includes the subject matter of any of Examples 1-4, and wherein the time property identifies intervals corresponding with one or more epochs, wherein each of the one or more epochs defines a time interval having a different granularity from each other epoch of the one or more epochs.

Example 6 includes the subject matter of any of Examples 1-5, and wherein one of the one or more epochs identifies the time interval as one of seconds, minutes, hours, days, or weeks.

Example 7 includes the subject matter of any of Examples 1-6, and wherein to determine the one or more features of the network traffic comprises to determine a feature

$$f ( {l}_{{i}_{1}} , {l}_{{i}_{2}} … , {l}_{{i}_{{c}_{M}}} , {p}_{{i}_{1}} , {p}_{{i}_{2}} … , {p}_{{i}_{{c}_{Q}}} , {t}_{{i}_{1}} , {t}_{{i}_{2}} … , {t}_{{i}_{{c}_{T}}} )$$

that includes c_{M} link properties indexed by i₁, i₂, . . . , i_{c}_{_{M}}; c_{Q} protocol properties indexed by i₁, i₂, . . . , i_{c}_{_{Q}}; and c_{T} time properties indexed by i₁, i₂, . . . , i_{c}_{_{T}}.

Example 8 includes the subject matter of any of Examples 1-7, and wherein to determine the feature comprises to assign a corresponding field value or wildcard value to each link property, protocol property, and time property of the feature.

Example 9 includes the subject matter of any of Examples 1-8, and wherein to generate the one or more observation vectors comprises to generate an observation vector, \tilde{v}, according to \tilde{v}=[ƒ₁: ƒ₂: . . . : ƒ_{d}], wherein ƒᵢ identifies an i^{th} feature of the observation vector and d identifies a dimension of the observation vector.

Example 10 includes the subject matter of any of Examples 1-9, and wherein the observation vector module is further to generate an observation matrix based on the one or more vectors according to:

$$[ \begin{matrix}{\tilde{v}}_{1} \\ {\tilde{v}}_{2} \\ ⋯ \\ {\tilde{v}}_{n}\end{matrix} ] = [ \begin{matrix}{f}_{1 , {\tilde{v}}_{1}} & {f}_{2 , {\tilde{v}}_{1}} & ⋯ & {f}_{d , {\tilde{v}}_{1}} \\ {f}_{1 , {\tilde{v}}_{2}} & {f}_{2 , {\tilde{v}}_{2}} & ⋯ & {f}_{d , {\tilde{v}}_{2}} \\ ⋮ & ⋮ & ⋱ & ⋮ \\ {f}_{1 , {\tilde{v}}_{n}} & {f}_{2 , {\tilde{v}}_{n}} & ⋯ & {f}_{d , {\tilde{v}}_{n}}\end{matrix} ] ,$$

wherein \tilde{v}ᵢ identifies an i^{th} observation vector and ƒ_{j,\tilde{v}}_{ₖ} identifies a j^{th} feature of a k^{th} observation vector.

Example 11 includes the subject matter of any of Examples 1-10, and wherein to perform the statistical network analysis comprises to perform principal component analysis (PCA) based on the generated one or more observation vectors.

Example 12 includes the subject matter of any of Examples 1-11, and wherein to perform the principal component analysis comprises to determine a covariance matrix that characterizes variations of the one or more observation vectors; and determine eigenvectors of the covariance matrix, wherein the eigenvectors define one or more principal components of the network traffic.

Example 13 includes the subject matter of any of Examples 1-12, and wherein to perform the statistical network analysis comprises to perform expectation maximization (EM) based on the generated one or more observation vectors.

Example 14 includes the subject matter of any of Examples 1-13, and wherein to perform the expectation maximization comprises to perform expectation maximization based on a Gaussian mixture model and the generated one or more observation vectors.

Example 15 includes the subject matter of any of Examples 1-14, and wherein to perform the expectation maximization comprises to maximize a likelihood of values of the one or more observation vectors.

Example 16 includes the subject matter of any of Examples 1-15, and further including a network provisioning module to generate dynamic provisioning instructions for the network based on the generated probabilistic model.

Example 17 includes the subject matter of any of Examples 1-16, and wherein to generate the dynamic provisioning instructions comprises to transmit an instruction to a packet scheduler to adjust a link capacity of a virtual network.

Example 18 includes the subject matter of any of Examples 1-17, and wherein the feature extraction module is to count data of network packets in the network traffic that are associated with the indexes of the one or more features for each of the one or more features.

Example 19 includes the subject matter of any of Examples 1-18, and, wherein to count the data of the network packets comprises to determine raw characteristics of the network packets.

Example 20 includes the subject matter of any of Examples 1-19, and wherein the raw characteristics of a corresponding network packet of the network packets include characteristics defined by a packet header of the corresponding network packet.

Example 21 includes the subject matter of any of Examples 1-20, and wherein to count the data of network packets comprises to count the data of network packets for a predetermined observation period.

Example 22 includes the subject matter of any of Examples 1-21, and wherein the predetermined observation period is at least as long as each of the intervals defined by the time property of the one or more features.

Example 23 includes the subject matter of any of Examples 1-22, and wherein to count the data of the network packets comprises to count bytes of the network packets.

Example 24 includes the subject matter of any of Examples 1-23, and further including a communication module to receive utilization data from an agent of a computer network node of the network, wherein the utilization data identifies one or more characteristics of the network packets in the network traffic.

Example 25 includes the subject matter of any of Examples 1-24, and wherein the network comprises a data network; and further comprising a communication module to receive control and management data from a network control node of the network via a management network different from the data network.

Example 26 includes a method for performing network analysis of a network by a network analytics node, the method comprising determining, by the network analytics node, one or more features of network traffic of the network, wherein each of the one or more features includes indexes associated with (i) a link property that identifies network links between computer network nodes of the network, (ii) a protocol property that identifies protocol field values of a header of a corresponding network packet, and (iii) a time property that identifies intervals over which the network traffic is to be monitored and analyzed; monitoring, by the network analytics node, the network traffic of the network based on the one or more features; generating, by the network analytics node, one or more observation vectors, wherein each of the one or more observation vectors includes a plurality of the one or more features based on the monitored network traffic; and performing, by the network analytics node, a statistical network analysis of the network traffic based on the generated one or more observation vectors to generate a probabilistic model of the network traffic.

Example 27 includes the subject matter of Example 26, and wherein the link property identifies network links of a subset of the network.

Example 28 includes the subject matter of any of Examples 26 and 27, and wherein the link property identifies one of a single network link; a set of network links; or zero network links.

Example 29 includes the subject matter of any of Examples 26-28, and wherein the protocol property identifies at least one of an internet protocol source address, an internet protocol destination address, a port number, or a protocol.

Example 30 includes the subject matter of any of Examples 26-29, and wherein the time property identifies intervals corresponding with one or more epochs, wherein each of the one or more epochs defines a time interval having a different granularity from each other epoch of the one or more epochs.

Example 31 includes the subject matter of any of Examples 26-30, and wherein one of the one or more epochs identifies the time interval as one of seconds, minutes, hours, days, or weeks.

Example 32 includes the subject matter of any of Examples 26-31, and wherein determining the one or more features of the network traffic comprises determining a feature

$$f ( {l}_{{i}_{1}} , {l}_{{i}_{2}} … , {l}_{{i}_{{c}_{M}}} . {p}_{{i}_{1}} , {p}_{{i}_{2}} … , {p}_{{i}_{{c}_{Q}}} , {t}_{{i}_{1}} , {t}_{{i}_{2}} … , {t}_{{i}_{{c}_{T}}} )$$

that includes c_{M} link properties indexed by i₁, i₂, . . . , i_{c}_{_{M}}; c_{Q} protocol properties indexed by i₁, i₂, . . . , i_{c}_{_{Q}}; and c_{T} time properties indexed by i₁, i₂, . . . , i_{c}_{_{T}}.

Example 33 includes the subject matter of any of Examples 26-32, and wherein determining the feature comprises assigning a corresponding field value or wildcard value to each link property, protocol property, and time property of the feature.

Example 34 includes the subject matter of any of Examples 26-33, and wherein generating the one or more observation vectors comprises generating an observation vector, \tilde{v}, according to \tilde{v}=[ƒ₁: ƒ₂: . . . : ƒ_{d}], wherein ƒᵢ identifies an i^{th} feature of the observation vector and d identifies a dimension of the observation vector.

Example 35 includes the subject matter of any of Examples 26-34, and, further including generating, by the network analytics node, an observation matrix based on the one or more vectors according to:

$$[ \begin{matrix}{\tilde{v}}_{1} \\ {\tilde{v}}_{2} \\ ⋯ \\ {\tilde{v}}_{n}\end{matrix} ] = [ \begin{matrix}{f}_{1 , {\tilde{v}}_{1}} & {f}_{2 , {\tilde{v}}_{1}} & ⋯ & {f}_{d , {\tilde{v}}_{1}} \\ {f}_{1 , {\tilde{v}}_{2}} & {f}_{2 , {\tilde{v}}_{2}} & ⋯ & {f}_{d , {\tilde{v}}_{2}} \\ ⋮ & ⋮ & ⋱ & ⋮ \\ {f}_{1 , {\tilde{v}}_{n}} & {f}_{2 , {\tilde{v}}_{n}} & ⋯ & {f}_{d , {\tilde{v}}_{n}}\end{matrix} ] ,$$

wherein \tilde{v}ᵢ identifies an i^{th} observation vector and ƒ_{j,\tilde{v}}_{ₖ} identifies a j^{th} feature of a k^{th} observation vector.

Example 36 includes the subject matter of any of Examples 26-35, and wherein performing the statistical network analysis comprises performing principal component analysis (PCA) based on the generated one or more observation vectors.

Example 37 includes the subject matter of any of Examples 26-36, and wherein performing the principal component analysis comprises determining a covariance matrix that characterizes variations of the one or more observation vectors; and determining eigenvectors of the covariance matrix, wherein the eigenvectors define one or more principal components of the network traffic.

Example 38 includes the subject matter of any of Examples 26-37, and wherein performing the statistical network analysis comprises performing expectation maximization (EM) based on the generated one or more observation vectors.

Example 39 includes the subject matter of any of Examples 26-38, and wherein performing the expectation maximization comprises performing expectation maximization based on a Gaussian mixture model and the generated one or more observation vectors.

Example 40 includes the subject matter of any of Examples 26-39, and wherein performing the expectation maximization comprises maximizing a likelihood of values of the one or more observation vectors.

Example 41 includes the subject matter of any of Examples 26-40, and further including generating, by the network analytics node, dynamic provisioning instructions for the network based on the generated probabilistic model.

Example 42 includes the subject matter of any of Examples 26-41, and wherein generating the dynamic provisioning instructions comprises transmitting an instruction to a packet scheduler to adjust a link capacity of a virtual network.

Example 43 includes the subject matter of any of Examples 26-42, and further including counting, by the network analytics node, data of network packets in the network traffic that are associated with the indexes of the one or more features for each of the one or more features.

Example 44 includes the subject matter of any of Examples 26-43, and wherein counting the data of the network packets comprises determining raw characteristics of the network packets.

Example 45 includes the subject matter of any of Examples 26-44, and wherein the raw characteristics of a corresponding network packet of the network packets include characteristics defined by a packet header of the corresponding network packet.

Example 46 includes the subject matter of any of Examples 26-45, and wherein counting the bytes of network packets comprises counting the data of network packets for a predetermined observation period.

Example 47 includes the subject matter of any of Examples 26-46, and wherein the predetermined observation period is at least as long as each of the intervals defined by the time property of the one or more features.

Example 48 includes the subject matter of any of Examples 26-47, and wherein counting the data of the network packets comprises counting bytes of the network packets.

Example 49 includes the subject matter of any of Examples 26-48, and, further including receiving, by the network analytics node, utilization data from an agent of a computer network node of the network, wherein the utilization data identifies one or more characteristics of the network packets in the network traffic.

Example 50 includes the subject matter of any of Examples 26-49, and wherein the network comprises a data network; and further comprising receiving, by the network analytics node, control and management data from a network control node of the network via a management network different from the data network.

Example 51 includes a computing device comprising a processor; and a memory having stored therein a plurality of instructions that when executed by the processor cause the computing device to perform the method of any of Examples 26-50.

Example 52 includes one or more machine readable storage media comprising a plurality of instructions stored thereon that in response to being executed result in a computing device performing the method of any of Examples 26-50.

Example 53 includes a computing device comprising means for performing the method of any of Examples 26-50.

Example 54 includes a network analytics node for performing network analysis of a network, the network analytics node comprising means for determining one or more features of network traffic of the network, wherein each of the one or more features includes indexes associated with (i) a link property that identifies network links between computer network nodes of the network, (ii) a protocol property that identifies protocol field values of a header of a corresponding network packet, and (iii) a time property that identifies intervals over which the network traffic is to be monitored and analyzed; means for monitoring the network traffic of the network based on the one or more features; means for generating one or more observation vectors, wherein each of the one or more observation vectors includes a plurality of the one or more features based on the monitored network traffic; and means for performing a statistical network analysis of the network traffic based on the generated one or more observation vectors to generate a probabilistic model of the network traffic.

Example 55 includes the subject matter of Example 54, and wherein the link property identifies network links of a subset of the network.

Example 56 includes the subject matter of any of Examples 54 and 55, and wherein the link property identifies one of a single network link; a set of network links; or zero network links.

Example 57 includes the subject matter of any of Examples 54-56, and wherein the protocol property identifies at least one of an internet protocol source address, an internet protocol destination address, a port number, or a protocol.

Example 58 includes the subject matter of any of Examples 54-57, and wherein the time property identifies intervals corresponding with one or more epochs, wherein each of the one or more epochs defines a time interval having a different granularity from each other epoch of the one or more epochs.

Example 59 includes the subject matter of any of Examples 54-58, and wherein one of the one or more epochs identifies the time interval as one of seconds, minutes, hours, days, or weeks.

Example 60 includes the subject matter of any of Examples 54-59, and wherein the means for determining the one or more features of the network traffic comprises means for determining a feature

$$f ( {l}_{{i}_{1}} , {l}_{{i}_{2}} … , {l}_{{i}_{{c}_{M}}} . {p}_{{i}_{1}} , {p}_{{i}_{2}} … , {p}_{{i}_{{c}_{Q}}} , {t}_{{i}_{1}} , {t}_{{i}_{2}} … , {t}_{{i}_{{c}_{T}}} )$$

that includes c_{M} link properties indexed by i₁, i₂, . . . , i_{c}_{_{M}}; c_{Q} protocol properties indexed by i₁, i₂, . . . , i_{c}_{_{Q}}; and c_{T} time properties indexed by i₁, i₂, . . . , i_{c}_{_{T}}.

Example 61 includes the subject matter of any of Examples 54-60, and wherein the means for determining the feature comprises means for assigning a corresponding field value or wildcard value to each link property, protocol property, and time property of the feature.

Example 62 includes the subject matter of any of Examples 54-61, and wherein the means for generating the one or more observation vectors comprises means for generating an observation vector, \tilde{v}, according to \tilde{v}=[ƒ₁: ƒ₂: . . . : ƒ_{d}], wherein ƒᵢ identifies an i^{th} feature of the observation vector and d identifies a dimension of the observation vector.

Example 63 includes the subject matter of any of Examples 54-62, and further including means for generating an observation matrix based on the one or more vectors according to:

$$[ \begin{matrix}{\tilde{v}}_{1} \\ {\tilde{v}}_{2} \\ ⋯ \\ {\tilde{v}}_{n}\end{matrix} ] = [ \begin{matrix}{f}_{1 , {\tilde{v}}_{1}} & {f}_{2 , {\tilde{v}}_{1}} & ⋯ & {f}_{d , {\tilde{v}}_{1}} \\ {f}_{1 , {\tilde{v}}_{2}} & {f}_{2 , {\tilde{v}}_{2}} & ⋯ & {f}_{d , {\tilde{v}}_{2}} \\ ⋮ & ⋮ & ⋱ & ⋮ \\ {f}_{1 , {\tilde{v}}_{n}} & {f}_{2 , {\tilde{v}}_{n}} & ⋯ & {f}_{d , {\tilde{v}}_{n}}\end{matrix} ] ,$$

wherein \tilde{v}ᵢ identifies an i^{th} observation vector and ƒ_{j,\tilde{v}}_{ₖ} identifies a j^{th} feature of a k^{th} observation vector.

Example 64 includes the subject matter of any of Examples 54-63, and wherein the means for performing the statistical network analysis comprises means for performing principal component analysis (PCA) based on the generated one or more observation vectors.

Example 65 includes the subject matter of any of Examples 54-64, and wherein the means for performing the principal component analysis comprises means for determining a covariance matrix that characterizes variations of the one or more observation vectors; and means for determining eigenvectors of the covariance matrix, wherein the eigenvectors define one or more principal components of the network traffic.

Example 66 includes the subject matter of any of Examples 54-65, and wherein the means for performing the statistical network analysis comprises means for performing expectation maximization (EM) based on the generated one or more observation vectors.

Example 67 includes the subject matter of any of Examples 54-66, and wherein the means for performing the expectation maximization comprises means for performing expectation maximization based on a Gaussian mixture model and the generated one or more observation vectors.

Example 68 includes the subject matter of any of Examples 54-67, and wherein the means for performing the expectation maximization comprises means for maximizing a likelihood of values of the one or more observation vectors.

Example 69 includes the subject matter of any of Examples 54-68, and further including means for generating dynamic provisioning instructions for the network based on the generated probabilistic model.

Example 70 includes the subject matter of any of Examples 54-69, and, wherein the means for generating the dynamic provisioning instructions comprises means for transmitting an instruction to a packet scheduler to adjust a link capacity of a virtual network.

Example 71 includes the subject matter of any of Examples 54-70, and further including means for counting data of network packets in the network traffic that are associated with the indexes of the one or more features for each of the one or more features.

Example 72 includes the subject matter of any of Examples 54-71, and wherein the means for counting the data of the network packets comprises means for determining raw characteristics of the network packets.

Example 73 includes the subject matter of any of Examples 54-72, and wherein the raw characteristics of a corresponding network packet of the network packets include characteristics defined by a packet header of the corresponding network packet.

Example 74 includes the subject matter of any of Examples 54-73, and wherein the means for counting the data of network packets comprises means for counting the data of network packets for a predetermined observation period.

Example 75 includes the subject matter of any of Examples 54-74, and wherein the predetermined observation period is at least as long as each of the intervals defined by the time property of the one or more features.

Example 76 includes the subject matter of any of Examples 54-75, and wherein the means for counting the data of the network packets comprises means for counting bytes of the network packets.

Example 77 includes the subject matter of any of Examples 54-76, and further including means for receiving utilization data from an agent of a computer network node of the network, wherein the utilization data identifies one or more characteristics of the network packets in the network traffic.

Example 78 includes the subject matter of any of Examples 54-77, and, wherein the network comprises a data network; and further comprising means for receiving control and management data from a network control node of the network via a management network different from the data network.

1. A network analytics node for performing network analysis of a network, the network analytics node comprising:
a feature extraction module to (i) determine one or more features of network traffic of the network, wherein each of the one or more features includes indexes associated with a link property that identifies network links between computer network nodes of the network, a protocol property that identifies protocol field values of a header of a corresponding network packet, and a time property that identifies intervals over which the network traffic is to be monitored and analyzed, and (ii) monitor the network traffic of the network based on the one or more features;
an observation vector module to generate one or more observation vectors, wherein each of the one or more observation vectors includes a plurality of the one or more features based on the monitored network traffic; and
a machine learning module to perform a statistical network analysis of the network traffic based on the generated one or more observation vectors to generate a probabilistic model of the network traffic.

2. The network analytics node of claim 1, wherein the link property identifies network links of a subset of the network.

3. The network analytics node of claim 1, wherein the time property identifies intervals corresponding with one or more epochs, wherein each of the one or more epochs defines a time interval having a different granularity from each other epoch of the one or more epochs; and
wherein one of the one or more epochs identifies the time interval as one of seconds, minutes, hours, days, or weeks.

4. The network analytics node of claim 1, wherein to determine the one or more features of the network traffic comprises to determine a feature
$$f ( {l}_{{i}_{1}} , {l}_{{i}_{2}} … , {l}_{{i}_{{c}_{M}}} . {p}_{{i}_{1}} , {p}_{{i}_{2}} … , {p}_{{i}_{{c}_{Q}}} , {t}_{{i}_{1}} , {t}_{{i}_{2}} … , {t}_{{i}_{{c}_{T}}} )$$
that includes:
c_{M} link properties indexed by i₁, i₂, . . . , i_{c}_{_{M}};
c_{Q} protocol properties indexed by i₁, i₂, . . . , i_{c}_{_{Q}}; and
c_{T} time properties indexed by i₁, i₂, . . . , i_{cT}.

5. The network analytics node of claim 1, wherein to determine the feature comprises to assign a corresponding field value or wildcard value to each link property, protocol property, and time property of the feature.

6. The network analytics node of claim 1, wherein to generate the one or more observation vectors comprises to generate an observation vector, \tilde{v}, according to \tilde{v}=[ƒ₁: ƒ₂: . . . : ƒ_{d}], wherein ƒᵢ identifies an i^{th} feature of the observation vector and d identifies a dimension of the observation vector.

7. The network analytics node of claim 6, wherein the observation vector module is further to generate an observation matrix based on the one or more vectors according to:
$$[ \begin{matrix}{\tilde{v}}_{1} \\ {\tilde{v}}_{2} \\ ⋯ \\ {\tilde{v}}_{n}\end{matrix} ] = [ \begin{matrix}{f}_{1 , {\tilde{v}}_{1}} & {f}_{2 , {\tilde{v}}_{1}} & ⋯ & {f}_{d , {\tilde{v}}_{1}} \\ {f}_{1 , {\tilde{v}}_{2}} & {f}_{2 , {\tilde{v}}_{2}} & ⋯ & {f}_{d , {\tilde{v}}_{2}} \\ ⋮ & ⋮ & ⋱ & ⋮ \\ {f}_{1 , {\tilde{v}}_{n}} & {f}_{2 , {\tilde{v}}_{n}} & ⋯ & {f}_{d , {\tilde{v}}_{n}}\end{matrix} ] ,$$
wherein \tilde{v}ᵢ identifies an i^{th} observation vector and ƒ_{j,\tilde{v}}_{ₖ} identifies a j^{th} feature of a k^{th} observation vector.

8. The network analytics node of claim 1, wherein to perform the statistical network analysis comprises to perform principal component analysis (PCA) based on the generated one or more observation vectors.

9. The network analytics node of claim 1, wherein to perform the principal component analysis comprises to:
determine a covariance matrix that characterizes variations of the one or more observation vectors; and
determine eigenvectors of the covariance matrix, wherein the eigenvectors define one or more principal components of the network traffic.

10. The network analytics node of claim 1, wherein to perform the statistical network analysis comprises to perform expectation maximization (EM) based on the generated one or more observation vectors.

11. The network analytics node of claim 10, wherein to perform the expectation maximization comprises to perform expectation maximization based on a Gaussian mixture model and the generated one or more observation vectors to maximize a likelihood of values of the one or more observation vectors.

12. The network analytics node of claim 1 further comprising a network provisioning module to generate dynamic provisioning instructions for the network based on the generated probabilistic model.

13. The network analytics node of claim 1, wherein the feature extraction module is to count data of network packets in the network traffic that are associated with the indexes of the one or more features for each of the one or more features.

14. The network analytics node of claim 13, wherein to count the data of the network packets comprises to count the data of the network packets for a predetermined observation period.

15. The network analytics node of claim 14, wherein the predetermined observation period is at least as long as each of the intervals defined by the time property of the one or more features.

16. The network analytics node of claim 1, further comprising a communication module to receive utilization data from an agent of a computer network node of the network, wherein the utilization data identifies one or more characteristics of the network packets in the network traffic.

17. One or more machine readable storage media comprising a plurality of instructions stored thereon that, in response to execution by a network analytics node, cause the network analytics node to:
determine one or more features of network traffic of the network, wherein each of the one or more features includes indexes associated with (i) a link property that identifies network links between computer network nodes of the network, (ii) a protocol property that identifies protocol field values of a header of a corresponding network packet, and (iii) a time property that identifies intervals over which the network traffic is to be monitored and analyzed;
monitor the network traffic of the network based on the one or more features;
generate one or more observation vectors, wherein each of the one or more observation vectors includes a plurality of the one or more features based on the monitored network traffic; and
perform a statistical network analysis of the network traffic based on the generated one or more observation vectors to generate a probabilistic model of the network traffic.

18. The one or more machine readable storage media of claim 17, wherein the link property identifies one of:
a single network link;
a set of network links; or
zero network links.

19. The one or more machine readable storage media of claim 17, wherein the time property identifies intervals corresponding with one or more epochs, wherein each of the one or more epochs defines a time interval having a different granularity from each other epoch of the one or more epochs.

20. The one or more machine readable storage media of claim 17, wherein the plurality of instructions further cause the network analytics node to count data of network packets in the network traffic that are associated with the indexes of the one or more features for each of the one or more features to determine raw characteristics of the network packets.

21. The one or more machine readable storage media of claim 17, wherein to determine the one or more features of the network traffic comprises to determine a feature
$$f ( {l}_{{i}_{1}} , {l}_{{i}_{2}} … , {l}_{{i}_{{c}_{M}}} . {p}_{{i}_{1}} , {p}_{{i}_{2}} … , {p}_{{i}_{{c}_{Q}}} , {t}_{{i}_{1}} , {t}_{{i}_{2}} … , {t}_{{i}_{{c}_{T}}} ) ,$$
that includes:
c_{M} link properties indexed by i₁, i₂, . . . , i_{c}_{_{M}};
c_{Q} protocol properties indexed by i₁, i₂, . . . , i_{c}_{_{Q}}; and
c_{T} time properties indexed by i₁, i₂, . . . , i_{cT}.

22. The one or more machine readable storage media of claim 17, wherein to generate the one or more observation vectors comprises to generate an observation vector, \tilde{v}, according to \tilde{v}=[ƒ₁: ƒ₂: . . . : ƒ_{d}], wherein ƒᵢ identifies an i^{th} feature of the observation vector and d identifies a dimension of the observation vector.

23. A method for performing network analysis of a network by a network analytics node, the method comprising:
determining, by the network analytics node, one or more features of network traffic of the network, wherein each of the one or more features includes indexes associated with (i) a link property that identifies network links between computer network nodes of the network, (ii) a protocol property that identifies protocol field values of a header of a corresponding network packet, and (iii) a time property that identifies intervals over which the network traffic is to be monitored and analyzed;
monitoring, by the network analytics node, the network traffic of the network based on the one or more features;
generating, by the network analytics node, one or more observation vectors, wherein each of the one or more observation vectors includes a plurality of the one or more features based on the monitored network traffic; and
performing, by the network analytics node, a statistical network analysis of the network traffic based on the generated one or more observation vectors to generate a probabilistic model of the network traffic.

24. The method of claim 23, wherein performing the statistical network analysis comprises performing at least one of principal component analysis (PCA) or expectation maximization (EM) based on the generated one or more observation vectors.

25. The method of claim 23, further comprising counting, by the network analytics node, bytes of network packets in the network traffic that are associated with the indexes of the one or more features for each of the one or more features.
